(19) United States
(12) Patent Application Publication
(10) Pub. No.: US 2010/0116517 A1
(43) Pub. Date: May 13, 2010

(54) HAND MACHINE TOOL, BATTERY PACK, AND CHARGER

(76) Inventors: Steffen Katzenberger, Bad Liebenzell (DE); Rainer Glauning, Aichtal-Groetzingen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/527,487

(22) PCT Filed: Dec. 19, 2007
(86) PCT No.: PCT/EP07/64182

§ 371 Date: Aug. 17, 2009

(30) Foreign Application Priority Data
Feb. 15, 2007 (DE) 102007007506.7

(51) Int. Cl. B25F 5/02; H02J 7/00; H01M 10/48

(52) U.S. Cl. 173/20; 320/114; 429/90

(57) ABSTRACT

The invention describes a hand machine tool, a battery pack, or a charger for at least one battery, or for a battery pack, having a housing, or part of a housing, made of at least one plastic, and having at least one indicator component mixed in with the at least one plastic.

### PRIOR ART

The invention relates to a hand-held power tool with a housing composed of at least one plastic, as recited in the preamble to claim 1. The invention also relates to a battery pack and a charger, each with a respective housing composed of at least one plastic, as recited in the preamble to the respective independent claim.

Products such as hand-held power tools, battery packs, chargers or the like cannot always be identified with absolute certainty. Particularly in the case of badly damaged products, e.g. battery packs destroyed by fire, it is sometimes difficult to verify whether it is original equipment provided by the manufacturer. Up to now, it has only been possible to identify products by means of the special plastic mixtures that are used for the housing of the battery pack or by means of microscopically small structures. The analysis required for this is sometimes complex and identification based on the analysis results is not always definite.

### DISCLOSURE OF THE INVENTION

The hand-held power tool according to the invention is characterized in that the housing or at least part of the housing is composed of a plastic or mixture of several plastics and at least one indicator component is mixed into the at least one plastic. The addition of an indicator component permits a definite, counterfeit-proof identification of the hand-held power tool. The indicator component can be detected by analyzing the composition of the chemical components of the housing. It is thus possible to identify the hand-held power tool and draw conclusions as to its origin. The indicator component can be used, for example in the event of damage, to determine whether or not the hand-held power tool is original equipment.

Another subject of the invention is a battery pack in which the housing or at least part of the housing is likewise composed of a plastic or a mixture of several plastics and at least one indicator component is mixed into the at least one plastic.

Finally, another subject of the invention is a charger for at least one battery or a battery pack, which is likewise comprised of a housing or at least part of a housing composed of a plastic or mixture of several plastics, with at least one indicator component being mixed into the at least one plastic.

In the context of the present invention, an “indicator component” is understood to be a component whose proportion in the material composition of the housing is significantly lower than all of the other components of the housing. For example, the proportion of the indicator component is at most 3 wt. %, in particular 0.01 to 2 wt. %, and can, for example, lie in the vicinity of 0.05 wt. %. An “indicator component” is also understood to have no influence or at most a negligible influence on the physical, chemical, or other properties of the coating. The indicator component behaves in a chemically inert fashion in relation to the plastic of the housing.

Identifying the origin of the hand-held power tool with absolute certainty is particularly possible if two or more indicator components are mixed into the plastic, which have a definite mass ratio to each other, e.g. of 1:2 or 1:3. The manufacturer of the hand-held power tool, battery pack, or charger according to the invention can thus select a characteristic mixture of two or more indicator components so as to permit definite identification of original equipment.

Preferably, the at least one indicator component is a temperature-resistant component. Preferably, metals are used as indicator components. A temperature-resistant indicator component has the advantage that it can still be detected by a chemical analysis, e.g. an element analysis, even if the housing has been seriously damaged, for example by fire. Metallic indicator components can be mixed into the plastic either in elementary form as a metal or in the form of a compound, e.g. an oxide compound, containing the metal.

Alternatively, the plastic can also have an indicator component mixed into it in the form of a compound that can be measured in a nondestructive fashion. For example, this can be an infrared-active compound that can be detected by means of an optical detection method such as measuring the reflection of infrared radiation against the surface of the plastic housing of the hand-held power tool. This has the advantage that the hand-held power tool, the battery pack, or the charger can also be identified in a nondestructive fashion in an undamaged product.

For example, ABS (acrylonitrile butadiene styrene) can be used as the plastic for the housing of the hand-held power tool, battery pack, or charger according to the invention. Manganese or magnesium can be used as metallic indicator components. For example, magnesium can be mixed into the plastic in the form of magnesium oxide. The two metals functioning as indicator components can be mixed in, for example, in a ratio of 1:2, with the total quantity of mixed-in indicator components amounting to 0.05 wt. %, for example.

The invention will be explained in greater detail below in conjunction with the accompanying drawings.

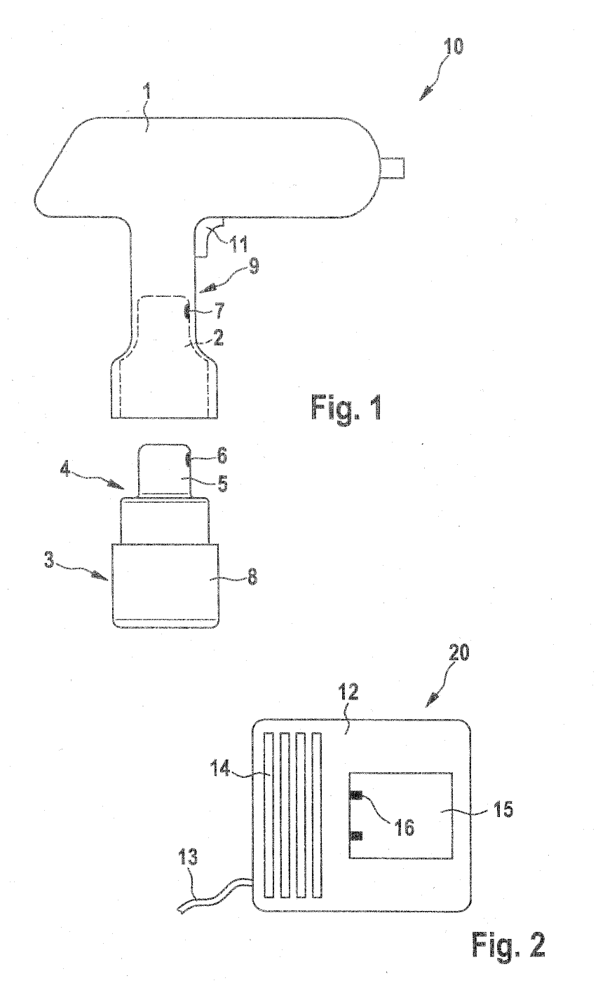

FIG. 1 is a schematic depiction of a hand-held power tool and a removable battery pack,

FIG. 2 is a schematically depicted top view of a charger.

FIG. 1 schematically depicts a housing 1 of a battery-operated hand-held power tool 10. In the handle region 9, a switch 11 is provided for switching the hand-held power tool 10 on and off. The hand-held power tool 10 has an interchangeable battery pack 3 as a voltage supply. To connect the battery pack 3 to the hand-held power tool 10, a socket 2 (depicted with dashed lines) for the battery pack 3 is provided at the bottom end of the handle region 9, opening toward the bottom. The housing 8 of the battery pack 3 has a connecting side 4, which is embodied in accordance with the socket 2, with which it can be inserted into the socket 2 on the machine housing 1. On the connecting side 4 of the battery pack 3, there is a protruding contact support 5 with electrical contacts 6 that come into an electrically conductive connection with electrical contacts 7 in the socket 2 when the battery pack 3 is inserted into the socket 2.

FIG. 2 schematically depicts a housing 12 of a charger 20 for charging a battery pack 3. The charger 20 is provided with a socket 15 for the battery pack 3. The battery pack 3 is inserted into the socket 15 for charging. This brings the electrical contacts 6 of the battery pack into an electrically conductive connection with the electrical contacts 16 of the charger 20. The charger 20 also has a power cord 13 to provide it with a voltage supply. In addition, ventilation openings 14 are provided in the housing 12 so that the charging electronics (not shown) in the housing 12 can be cooled during the charging process.

According to the invention, the housing 1 or at least a part of the housing 1 of the hand-held power tool 10, the housing 8 of the battery pack 3, and/or the housing 12 of the charger 20 is/are composed of a plastic such as ABS (acrylonitrile butadiene styrene) or a mixture of several plastics and at least one indicator component is mixed into the at least one plastic in order to assure a definite, counterfeit-proof identification of the hand-held power tool 10, battery pack 3, and/or charger 20. The indicator component can be detected by analyzing the composition of the chemical components of the housing 1, 8, 12. For example, the plastic has two indicator components such as manganese and magnesium mixed into it, which are in a definite mass ratio to each other such as 1:2. For example, the proportion of indicator component is at most 3 wt. %, in particular from 0.01 to 2 wt. %, and can, for example, lie in the vicinity of 0.05 wt. %.

1-6. (canceled)

7. A hand-held power tool having a housing or a part of a housing composed of at least one plastic, and having at least one indicator component mixed into the at least one plastic.

8. The hand-held power tool as recited in claim 7, wherein the at least one indicator component is temperature-resistant.

9. The hand-held power tool as recited in claim 7, wherein the at least one indicator component is a metal.

10. The hand-held power tool as recited in claim 8, wherein the at least one indicator component is a metal.

11. The hand-held power tool as recited in claim 7, wherein two or more indicator components are mixed in, which have a definite mass ratio to each other.

12. The hand-held power tool as recited in claim 8, wherein two or more indicator components are mixed in, which have a definite mass ratio to each other.

13. The hand-held power tool as recited in claim 9, wherein two or more indicator components arc mixed in, which have a definite mass ratio to each other.

14. The hand-held power tool as recited in claim 10, wherein two or more indicator components are mixed in, which have a definite mass ratio to each other.

15. A battery pack having a housing or a part of the housing composed of at least one plastic, and having at least one indicator component mixed into the at least one plastic.

16. A charger for at least one battery or battery pack, having a housing or a part of the housing composed of at least one plastic, and having at least one indicator component mixed into the at least one plastic.
